(19) United States
(12) Patent Application Publication
(10) Pub. No.: US 2010/0094679 A1
(43) Pub. Date: Apr. 15, 2010

(54) ESTABLISHING AND MANAGING MENTOR-PROTEGE RELATIONSHIPS

(75) Inventors: Michael L. Diehl, Lee's Summit, MO (US); Vivian A. Tate, Kansas City, MO (US); Mia J. Sheppard, Kansas City, MO (US); Chris M. Worley, Overland Park, KS (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: EMBARQ HOLDINGS COMPANY, LLC

(21) Appl. No.: 12/250,070

(22) Filed: Oct. 13, 2008

(51) Int. Cl. G06Q 10/00; G06F 17/30

(52) U.S. Cl. 705/9; 707/E17.135

(57) ABSTRACT

Methods, systems and computer readable medium for establishing a relationship between a mentor and a protégé in a workplace. The relationship is established after executing a query of a database to find matches between attributes of a requesting prospective protégé and attributes of a number of candidate mentors, where the database stores attributes of each candidate mentor. The requesting prospective protégé and the candidate mentors are both employed in the workplace, and the matches are determined in accordance with a policy of the workplace. Based on results of the query, an invitation is made to a first candidate mentor. The invitation includes attributes of the requesting prospective protégé and a request that the first candidate mentor accept a mentor-protégé relationship with the requesting protégé. The prospective protégé is notified of an identity and selected attributes of the first candidate mentor only after the first candidate mentor accepts the request.

### FIELD OF THE INVENTION

The field of the invention relates in general to establishing and managing a mentoring relationship in a workplace, in particular to an automated method for anonymously matching a protégé to a mentor in compliance with a human resource policy.

### BACKGROUND OF THE INVENTION

Fostering a developmental relationship between a relatively well experienced “mentor” and a relatively less experienced “protégé” is a well-known way to enhance learning, personal and/or professional development of (at least) the protégé. Computer-aided tools to match mentors and protégés have been disclosed, for example, in Fox, et al., U.S. 2006/0031087, where a “bidirectional” matching method based on demographics, preferences and personal information is described. The method provides a student-protégé with a list of “most suitable” mentor candidates from a pool of mentor candidates from which list the student-protégé makes a final selection.

### SUMMARY

The known methods of matching protégé and mentor are not satisfactory when the protégé and mentor pool are associated with a common employer or workplace because, among other reasons, the choice of a mentor, based on attributes including personal information about several candidate mentors, is left to the protégé. Where the protégé and mentor pool share a common employer, the known methods fail to appreciate that the mentor candidate, not the protégé, is preferably the person to accept or decline a computer-proposed mentor-protégé relationship, because the mentor will generally be the more senior member of the employer's organization.

In developing a mentor-protégé program, an employer may wish to encourage senior employers to volunteer to serve as mentors. In methods known to the prior art, such mentor candidates may be deterred from volunteering, because the protégé is given the opportunity to select a preferred mentor based on a mentor's personal attributes. This is problematic at least because a mentor who may not be available or interested to serve at a particular time (or with a particular prospective protégé) will be faced with the necessity to decline a protégé's invitation knowing that the anonymity of the mentor candidate is not preserved from the requesting prospective protégé.

The present inventors have recognized and solved these problems with a method and system that establishes a relationship between a mentor and a protégé in a workplace by executing a query of a database to find matches between attributes of a requesting prospective protégé and attributes of a plurality of candidate mentors, where the database includes attributes of each of the plurality of candidate mentors. The requesting prospective protégé and the candidate mentors ate employed in the workplace, and said matches are determined in accordance with a policy of the workplace. An invitation is made, based on results of the query, to a first candidate mentor from among the candidate mentors. The invitation includes attributes of the requesting prospective protégé and a request that the first candidate mentor accept a mentor-protégé relationship with the requesting protégé. The prospective protégé is notified of an identity and selected attributes of the first candidate mentor only when the first candidate mentor accepts the request.

In an embodiment, the prospective protégé is notified by providing the identity and selected attributes of only the first candidate mentor and the identity and attributes of at least one other candidate mentor are kept secret from the prospective protégé. In a further embodiment, any instance of a candidate mentor declining a request is kept secret from the prospective protégé.

In an embodiment, the selected attributes are selected in accordance with the policy of the workplace.

In another embodiment an invitation is made, based on results of the query, to a second candidate mentor from among the candidate mentors when the first candidate mentor declines a relationship with the requesting prospective protégé. The invitation includes attributes of the requesting prospective protégé and a request that the second candidate mentor accept a mentor-protégé relationship with the requesting protégé. The prospective protégé is notified of an identity and selected attributes of the second candidate mentor only when the second candidate mentor accepts the request.

In a further embodiment, the database is linked to a human resource database of the workplace.

In yet a further embodiment, at least some attributes of the requesting prospective protégé are obtained from the human resource database. These attributes may, but do not necessarily, include: present position within the workplace, current assignments, past reporting relationships within the workplace, and/or information regarding a past mentoring relationship.

In an embodiment the policy applies different weights to different attributes.

In another embodiment, the policy weighs a plurality of factors in furtherance both of a successful mentor-protégé relationship and a broader objective of the workplace.

In a further embodiment, the invitation comprises only selected attributes of the requesting prospective protégé, and the selected attributes are selected in accordance with the policy.

In an embodiment, the policy comprises avoiding making an invitation to a candidate mentor having less availability in favor of a candidate mentor having greater availability.

### BRIEF DESCRIPTION OF THE DRAWINGS

Illustrative embodiments of the principles of the present invention are described in detail below with reference to the attached drawing figures, which are incorporated by reference herein and wherein:

FIG. 1 is a flowchart of one embodiment of an illustrative method for establishing and managing a mentor-protégé relationships; and

FIG. 2 is a block diagram of one embodiment of an illustrative system for establishing and managing a mentor-protégé relationship.

### DETAILED DESCRIPTION OF THE DRAWINGS

A detailed description of preferred embodiments of the present invention is provided hereinbelow. It is to be understood, however, that the disclosed embodiments are merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

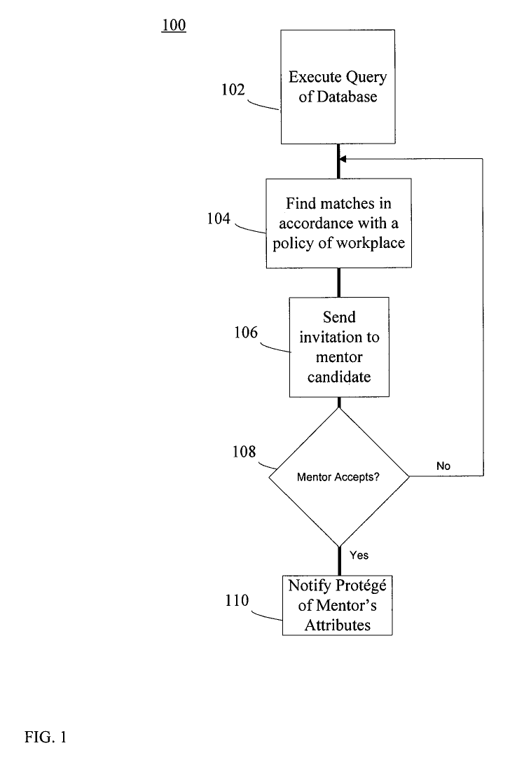

Referring now to FIG. 1, a method 100 for enabling and managing a mentor-protégé relationship is described. In step 102, a database query may be executed upon, for example, a request of a prospective protégé desiring to enter into a mentor-protégé relationship. The mentor and protégé may share a common workplace, by which is meant, here and in the claims, that each of the mentor and protégé are employed by or on behalf of a common organization. The mentor and protégé may nevertheless be substantially separated geographically, as may be the case, for example, where the workplace of the organization comprises many separately located business units or divisions. The database may consist of records of candidate mentors, who may be, for example, relatively senior employees or managers within the workplace. Each record stored in the database may contain attributes of a mentor related to the mentor's professional experience and areas of expertise. Depending on the policy of the workplace, the record may include personal demographic information and personal interests of the mentor. The attributes may be collected in the form of answers to a survey questionnaire, for example, and may include information related to attributes preferred by the mentor in a prospective protégé, and/or may specify a maximum number of protégés the mentor is willing to engage with at a given time. The questionnaire form may be prepared by and/or be maintained under the control of the workplace. The workplace, moreover, may undertake to ensure the confidentiality of the records. The records may include additional attributes of each candidate mentor taken, for example, from the workplace's human resource databases and including such matters as the candidate mentor's present position within the workplace, current assignments, past reporting relationships within the workplace, the details of past mentoring relationships, or any other suitable information.

Executing a query 102 may be directed at finding matches 104 between attributes of a prospective protégé and attributes of a candidate mentor. Attributes of the prospective protégé may be related to the protégé's professional experience and specific developmental needs and desires. Depending on the policy of the workplace, the attributes may include personal demographic information and personal interests of the prospective protégé as well. The attributes may be collected in the form of answers to a survey questionnaire or “request for mentor” form, for example, and may include information related to attributes preferred by the protégé in a candidate mentor. The questionnaire/request for mentor form may be prepared by and/or be maintained under the control of the workplace. The workplace, moreover, may undertake to ensure the confidentiality of the request. The prospective protégé's attributes provided on such a form may be supplemented by additional attributes of the prospective protégé taken, for example, from the workplace's human resource databases and including such matters as the prospective protégé's present position within the workplace, current assignments, past reporting relationships within the workplace, the details of past mentoring relationships, or any other suitable information.

In step 104 matches are determined between attributes of a prospective protégé and attributes of a candidate mentor. The determination of what constitutes a “match” may advantageously be made in accordance with a policy of the workplace. The policy may be designed to apply different weights to different attributes, and/or to disregard certain attributes. For example, the policy may prevent matching the prospective protégé with a candidate mentor who is in the direct supervisory chain of the protégé. Moreover, the policy may give greater or lesser weight to geographic proximity of the prospective protégé to a candidate mentor, depending, for example, on whether the prospective protégé indicated a preference to be mentored face-to-face. As a result of the information entered into the database by each candidate mentor and prospective protégé, coupled with preexisting organizational information regarding each, the policy may be designed to weigh a large variety of factors in furtherance both of a successful mentor-protégé relationship and the workplace's broader objectives, such as improving the efficiency of the workforce.

Step 104 may include finding matching attributes of the prospective protégé and attributes of, preferably, two or more candidate mentors. When multiple candidate mentors are identified as having attributes that match those of the prospective protégé within a tolerance determined by the policy, the policy may further include selecting a first candidate member from among the multiple candidate mentors. This selection, for example, may be made on the basis of “availability”, by which is meant a candidate mentor may be preferred who has, for example, a lighter current workload, or the fewest other current mentoring relationships.

In step 106, the method may generate an invitation to the first candidate mentor to accept a mentor-protégé relationship with the requesting prospective protégé. The invitation may include at least some selected attributes of the prospective protégé. The nature and extent of the attributes provided to the candidate mentor may be adjusted in accordance with the policy of the workplace. The policy of the workplace may, for example, be to find matches based on the entire universe of information known to the workplace about the protégé and the candidate mentors, but to only disclose selected attributes to a candidate mentor. For example, the workplace database may include information which, for reasons of employee privacy, the workplace wishes to avoid providing to the candidate mentor. Moreover, in implementing its policy the workplace may provide a “request for mentor” form having one section for information that is expressly to be provided to a candidate mentor, and another section for information that is expressly to be kept secret within, for example a human resource department of the workplace.

In step 108, the first candidate mentor may accept or decline the invitation. The decision 108 may be based on any criteria, for example, the first candidate mentor's current workload, personal conflicts, or the attributes of the prospective protégé. The method may provide that the identity and other attributes of a declining candidate mentor are never disclosed to the prospective protégé. Moreover, even the fact that an invitation was declined may not be communicated to the prospective protégé.

In the event the first candidate mentor accepts the invitation at step 108, a mentor-protégé relationship may be established, and the protégé may be notified at step 110 of the relationship and provided at least some attributes of the accepting mentor. The nature and extent of the attributes provided to the protégé may be adjusted in accordance with the policy of the workplace. For example, the policy may provide disclosure to the protégé only of attributes of the mentor which the mentor has agreed may be disclosed.

In the event the first candidate mentor declines the invitation at step 108, the method may repeat step 104. If the first candidate mentor was selected from multiple matching candidate mentors previously identified at step 104, as discussed above, the method may now select a second candidate mentor (based on availability, for example) and re-execute the process steps 106 and 108. The method contemplates that these steps may be repeated multiple times.

Once a mentor-protégé relationship is established, the method may include provisions for managing and facilitating the relationship in accordance with the policy of the workplace. For example, automated reminders regarding meetings and action items relating to the relationship may be provided. As a further example, the method may provide that the mentor and/or protégé complete evaluations of their respective partner and of the overall mentor-protégé relationship so as to facilitate future improvements in the workplace's mentor-protégé relationship program.

Thus, an automated method for establishing and managing a mentoring relationship in a workplace by matching a protégé to a mentor in compliance with a human resource policy has been disclosed.

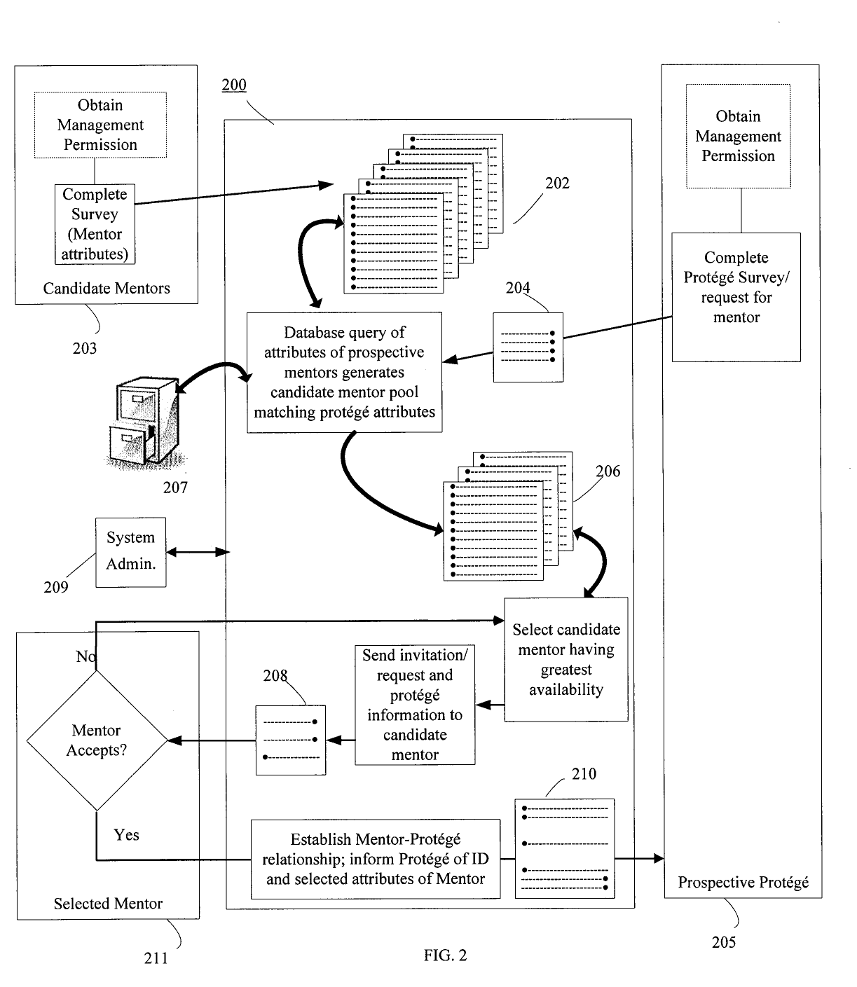

A further embodiment will now be described with reference to FIG. 2. A system 200 establishes and manages a mentor-protégé relationship within the framework of a common workplace, by which is meant that each of the mentor and protégé are employed by or on behalf of a common organization. The mentor and protégé may nevertheless be substantially separated geographically, as may be the case, for example, where the workplace of the organization comprises many separately located business units or divisions. The system 200 may be advantageously embodied as a computerized tool, including, for example, an electronic database, and software for organizing and searching the database and selecting records from the database. As such, system 200 may advantageously be communicatively coupled to one or more candidate mentors 203 and at least one prospective protégé 205 by way, for example, of a corporate intranet, the Internet, or other electronics means. Features of system 200 may advantageously be designed and maintained in accordance with a policy such as a human resource policy of the workplace. System 200 may also be communicatively coupled to a system administrator 209, to whom operation and maintenance of the system may be delegated by the workplace and/or to a human resources database 207.

In an embodiment, candidate mentors 203 may indicate their availability to serve as mentors by completing, for example, survey questionnaires. Depending on the policy of the workplace, candidate mentors may first be required to obtain management permission to participate in a mentor-protégé program. Completed survey questionnaires (or the like) from a number of candidate mentors 203 form a database 202. As discussed hereinabove, database 202 may include, in addition to completed questionnaires (or the like), additional attributes of each candidate mentor taken, for example, from the workplace's human resource databases and including such matters as the candidate mentor's present position within the workplace, and current assignments, as well as past reporting relationships within the workplace, the details of past mentoring relationships and the like.

In an embodiment, a prospective protégé 205 may indicate an interest in entering into a mentor-protégé relationship by completing, for example, a protégé survey/request for mentor. Depending on the policy of the workplace, a prospective protégé may first be required to obtain management permission to participate in a mentor-protégé program. A completed request 204 may constitute a request to query database 202 for candidate mentors having matching attributes. Before executing the request, the completed request 204 may be supplemented by additional attributes of the prospective protégé taken, for example, from the workplace's human resource databases and including such matters as the prospective protégé's present position within the workplace, and current assignments, as well as past reporting relationships within the workplace, the details of past mentoring relationships, and the like.

The system 200 may execute the query of database 202 in order to produce a candidate mentor pool 206, members of the pool 206 having attributes that “match” attributes of the prospective protégé 205. The determination of what constitutes a “match” may advantageously be made in accordance with a policy of the workplace. The policy may be designed to apply different weights to different attributes, and/or to disregard certain attributes. For example, the policy may prevent matching the prospective protégé 205 with a candidate mentor who is in the direct supervisory chain of the prospective protégé 205. Moreover, the policy may give greater or lesser weight to geographic proximity of the prospective protégé 205 to a candidate mentor depending, for example, on whether the prospective protégé 205 indicated a preference to be mentored face-to-face. As a result of the information entered into the database 202 by each candidate mentor and prospective protégé 205, coupled with preexisting workplace/human resource information 207 regarding each candidate mentor and the prospective protégé 205, the policy may be designed to weigh a large variety of factors in furtherance both of a successful mentor-protégé relationship and the workplace's broader objectives.

The system 200 may identify a selected mentor 211 from candidate mentor pool 206 on the basis of availability. Candidate mentors in mentor pool 206 already engaged in one or more mentor-protégé relationships (or otherwise known by the workplace to have less availability) may be bypassed in favor of a candidate mentor who has, for example, a lighter current workload, or the fewest other current mentoring relationships. The selected mentor 211 may be sent an invitation/request to engage in a mentor-protégé relationship with the prospective protégé 205. The invitation/request may advantageously be accompanied by attributes, including personal information 208, of the prospective protégé 205. These attributes may include some or all of the information provided by the prospective protégé on the completed request 204. Advantageously, the system 200 may apply a policy of the workplace such that the protégé information 208 provided to the selected mentor 211 is not identical to the completed request 204. For example, certain attributes on the completed request 204 may be kept secret from the selected mentor 211 in accordance with the workplace's policy. On the other hand, in accordance with the policy, additional information about the prospective protégé 205, not provided on completed request 204, may be provided. Such additional information may be available, for example in the preexisting organizational/human resource information 207.

The selected candidate mentor 211, upon receiving the protégé information 208, may accept or decline entering into the proposed mentor-protégé relationship. If the selected mentor 211 declines the proposed mentor-protégé relationship, the system 200 may select a second candidate mentor from candidate mentor pool 206 on the basis of availability. If necessary, the above described iteration may be repeated multiple times.

When a selected mentor 211, upon receiving the protégé information 208, accepts entering into the proposed mentor-protégé relationship, the system 200 may establish the relationship and provide to the prospective protégé 205 selected attributes 210 of the selected mentor 211. The elements of selected attributes 210 may be advantageously selected on the basis of the policy of the workplace. For example, certain attributes of the selected mentor 211 provided by the mentor upon completing a survey questionnaire may be kept secret from the prospective protégé 205 in accordance with the workplace's policy. On the other hand, in accordance with the policy, additional information about the selected mentor 211 may be provided. Such additional information may be available, for example in the preexisting human resource information 207.

Once a mentor-protégé relationship is established, the system may help manage and facilitate the relationship in accordance with the policy of the workplace. For example, automated reminders regarding meetings and action items relating to the relationship may be provided. As a further example, the system may provide that the mentor and/or protégé complete evaluations of their respective partner and of the overall mentor-protégé relationship so as to facilitate future improvements in the workplaces mentor-protégé relationship program.

Although the foregoing detailed description has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall within the true spirit and scope of the underlying principles disclosed and claimed herein. Consequently, the scope of the present invention is intended to be limited only by the attached claims; all matter contained in the above description and shown in the accompanying drawings shall be interpreted as illustrative and not in a limiting sense.

What is claimed:

1. A method for establishing a relationship between a mentor and a protégé in a workplace, said method comprising:
executing a query of a database to find matches between attributes of a requesting prospective protégé and attributes of a plurality of candidate mentors, said database comprising attributes of each of the plurality of candidate mentors, said requesting prospective protégé and said plurality of candidate mentors being employed in the workplace, and said matches being determined in accordance with a policy of the workplace;
making an invitation, based on results of the query, to a first candidate mentor from among the plurality of candidate mentors, said invitation comprising attributes of the requesting prospective protégé and a request that the first candidate mentor accept a mentor-protégé relationship with the requesting protégé; and
notifying the prospective protégé of an identity and selected attributes of the first candidate mentor only when the first candidate mentor accepts the request.

2. The method of claim 1, wherein notifying the prospective protégé comprises providing the identity and selected attributes of only the first candidate mentor and the identity and attributes of at least one other candidate mentor are kept secret from the prospective protégé.

3. The method of claim 2, wherein any instance of a candidate mentor declining a request is kept secret from the prospective protégé.

4. The method of claim 1, wherein the selected attributes are selected in accordance with the policy of the workplace.

5. The method of claim 1, further comprising:
making an invitation, based on results of the query, to a second candidate mentor from among the plurality of candidate mentors when the first candidate mentor declines a relationship with the requesting prospective protégé, said invitation comprising attributes of the requesting prospective protégé and a request that the second candidate mentor accept a mentor-protégé relationship with the requesting protégé; and
notifying the prospective protégé of an identity and selected attributes of the second candidate mentor only when the second candidate mentor accepts the request.

6. The method of claim 1, wherein the database is linked to a human resource database of the workplace.

7. The method of claim 6, wherein at least some attributes of the requesting prospective protégé are obtained from the human resource database.

8. The method of claim 7, wherein the at least some attributes comprise at least one of the following characteristics of the prospective protégé: present position within the workplace, current assignments, past reporting relationships within the workplace, and information regarding a past mentoring relationship.

9. The method of claim 1, wherein the policy applies different weights to different attributes.

10. The method of claim 1 wherein the policy weighs a plurality of factors in furtherance both of a successful mentor-protégé relationship and a broader objective of the workplace.

11. The method of claim 1, wherein the invitation comprises only selected attributes of the requesting prospective protégé, said selected attributes being selected in accordance with the policy.

12. The method of claim 1 wherein the policy comprises avoiding making an invitation to a candidate mentor having less availability in favor of a candidate mentor having greater availability.

13. A system for establishing a relationship between a mentor and a protégé in a workplace, said system comprising a computerized tool adapted to:
execute a query of a database to find matches between attributes of a requesting prospective protégé and attributes of a plurality of candidate mentors, said database comprising attributes of each of the plurality of candidate mentors, said requesting prospective protégé and said plurality of candidate mentors being employed in the workplace, and said matches being determined in accordance with a policy of the workplace;
make an invitation, based on results of the query, to a first candidate mentor from among the plurality of candidate mentors, said invitation comprising attributes of the requesting prospective protégé and a request that the first candidate mentor accept a mentor-protégé relationship with the requesting protégé; and
notify the prospective protégé of an identity and selected attributes of the first candidate mentor only when the first candidate mentor accepts the request.

14. The system of claim 13, wherein the system notifies the prospective protégé by providing the identity and selected attributes of only the first candidate mentor and the identity and attributes of at least one other candidate mentor are kept secret from the prospective protégé.

15. The system of claim 14, wherein any instance of a candidate mentor declining a request is kept secret from the prospective protégé.

16. The system of claim 13, wherein the selected attributes are selected in accordance with the policy of the workplace.

17. The system of claim 13, further adapted to:
make an invitation, based on results of the query, to a second candidate mentor from among the plurality of candidate mentors when the first candidate mentor declines a relationship with the requesting prospective protégé, said invitation comprising attributes of the requesting prospective protégé and a request that the second candidate mentor accept a mentor-protégé relationship with the requesting protégé; and
notify the prospective protégé of an identity and selected attributes of the second candidate mentor only when the second candidate mentor accepts the request.

18. The system of claim 13, wherein the database is linked to a human resource database of the workplace.

19. The system of claim 18, wherein at least some attributes of the requesting prospective protégé are obtained from the human resource database.

20. A computer readable medium having at least one of a computer program and a database recorded thereon, whereby a computerized tool is enabled to:
execute a query of a database to find matches between attributes of a requesting prospective protégé and attributes of a plurality of candidate mentors, said database comprising attributes of each of the plurality of candidate mentors, said requesting prospective protégé and said plurality of candidate mentors being employed in the workplace, and said matches being determined in accordance with a policy of the workplace;
make an invitation, based on results of the query, to a first candidate mentor from among the plurality of candidate mentors, said invitation comprising attributes of the requesting prospective protégé and a request that the first candidate mentor accept a mentor-protégé relationship with the requesting protégé; and
notify the prospective protégé of an identity and selected attributes of the first candidate mentor only when the first candidate mentor accepts the request.
